(19) United States
(12) Patent Application Publication
(10) Pub. No.: US 2018/0106166 A1
(43) Pub. Date: Apr. 19, 2018

(54) FEEDWATER BYPASS SYSTEM FOR A DESUPERHEATER

(71) Applicant: General Electric Technology GmbH, Baden (CH)

(72) Inventors: Luca Sala, Habsburg (CH); Anand Nagasayanam, Wettingen (CH)

(21) Appl. No.: 15/296,273

(22) Filed: Oct. 18, 2016

(51) Int. Cl. F01K 3/18; F01D 15/10; F01K 7/16; F01K 7/34; F01K 13/00; F01K 23/10; F01K 15/00; F01N 5/02; F02C 6/18; F02C 3/04; H02K 7/18

(52) U.S. Cl. CPC F01K 3/185; F05D 2220/72; F01K 7/16; F01K 7/345; F01K 13/00; F01K 23/10; F01K 15/00; F01N 5/02; F02C 6/18; F02C 3/04; H02K 7/1823; F05D 2220/31; F05D 2220/32; F05D 2220/62; F01D 15/10

(57) ABSTRACT

The present application provides a combined cycle system. The combined cycle system may include a heat recovery steam generator, a feedwater source positioned upstream of the heat recovery steam generator, a desuperheater positioned downstream of the heat recovery steam generator, a first extraction from the heat recovery steam generator to the desuperheater, and a second extraction from upstream of the heat recovery steam generator to the desuperheater.

### TECHNICAL FIELD

The present application and the resultant patent relate generally to a combined cycle system using a gas turbine engine and more particularly relate to a feedwater bypass system for use with a desuperheater of a heat recovery steam generator for increased cooling capacity.

### BACKGROUND OF THE INVENTION

A combined cycle power generation system uses a combination of a gas turbine and a steam turbine to produce electrical power and/or otherwise to drive a load. Specifically, a gas turbine cycle may be operatively combined with a steam turbine cycle by way of a heat recovery steam generator. The heat recovery steam generator may be a multi-section heat exchanger that allows feedwater for the steam generation process to be heated and expanded by the hot combustion gases of the gas turbine exhaust. The primary efficiency of the combined cycle system arrangement is the utilization of the otherwise “wasted” heat of the hot combustion gases from the gas turbine. Power plant operators thus aim to generate the maximum possible useful work from the heat in the gas turbine exhaust.

A combined cycle system may include a desuperheater positioned between a final stage of a high pressure superheater of the heat recovery steam generator and one of the sections of the steam turbine. The desuperheater may control the temperature of the steam leaving the final stage of the superheater. The desuperheater injects a water spray into the main steam flow. A straight pipe length for the water flow thus may be required to ensure sufficient water vaporization before reaching a first pipe elbow. If proper vaporization of the water spray is not achieved before reaching the first elbow of the main steam pipe downstream of the desuperheater, erosion may occur due to water impingement. Such erosion issues further may be increased due to plant upgrades or changes in the overall plant operating concept such as fast start up to fulfill grid requirements and the like. The determination of the minimum length of this straight pipe may depend on the minimum residence time required for the flow. This time may be a function of the amount of water injected as well as the velocity of the water. As the water flow increases, the length of the straight pipe required to ensure complete water vaporization also may increase.

Typically, the water injection flow is extracted from an economizer of the heat recovery steam generator. The cooling capacity of the desuperheater may be increased by using only cold water. Using cold water, however, may result in a higher thermal shock being transferred to the thermal liner downstream of the desuperheater as well as to the pipe metal surfaces. The consequence of such higher thermal shock may be an increased probability of pipe cracks and other damage.

### SUMMARY OF THE INVENTION

The present application and the resultant patent thus provide a combined cycle system. The combined cycle system may include a heat recovery steam generator, a feedwater source positioned upstream of the heat recovery steam generator, a desuperheater positioned downstream of the heat recovery steam generator, a first extraction from the heat recovery steam generator to the desuperheater, and a second extraction from upstream of the heat recovery steam generator to the desuperheater.

The present application and the resultant patent further provide a method of controlling a temperature of a flow of superheated steam from a heat recovery steam generator in a desuperheater. The method may include the steps of flowing steam from a superheater of the heat recovery steam generator to the desuperheater, receiving a first extraction from an economizer of the heat recovery steam generator to the desuperheater, and variably receiving a bypass extraction of feedwater from upstream of the heat recovery steam generator to the desuperheater.

The present application and the resultant patent further provide a combined cycle system. The combined cycle system may include a heat recovery steam generator with an economizer and a superheater, a feedwater source positioned upstream of the heat recovery steam generator, a desuperheater positioned downstream of the superheater of the heat recovery steam generator, a first extraction from the economizer of heat recovery steam generator to the desuperheater, and a second extraction of feedwater from upstream of the heat recovery steam generator to the desuperheater.

These and other features of the improvements of the present application and the resulting patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a combined cycle system including a gas turbine engine, a heat recovery steam generator, and a steam turbine.

FIG. 2 is a schematic diagram of a high pressure section of a heat recovery steam generator with a final stage desuperheater.

FIG. 3 is a schematic diagram of a feedwater bypass system for use with the desuperheater as may be described herein.

### DETAILED DESCRIPTION

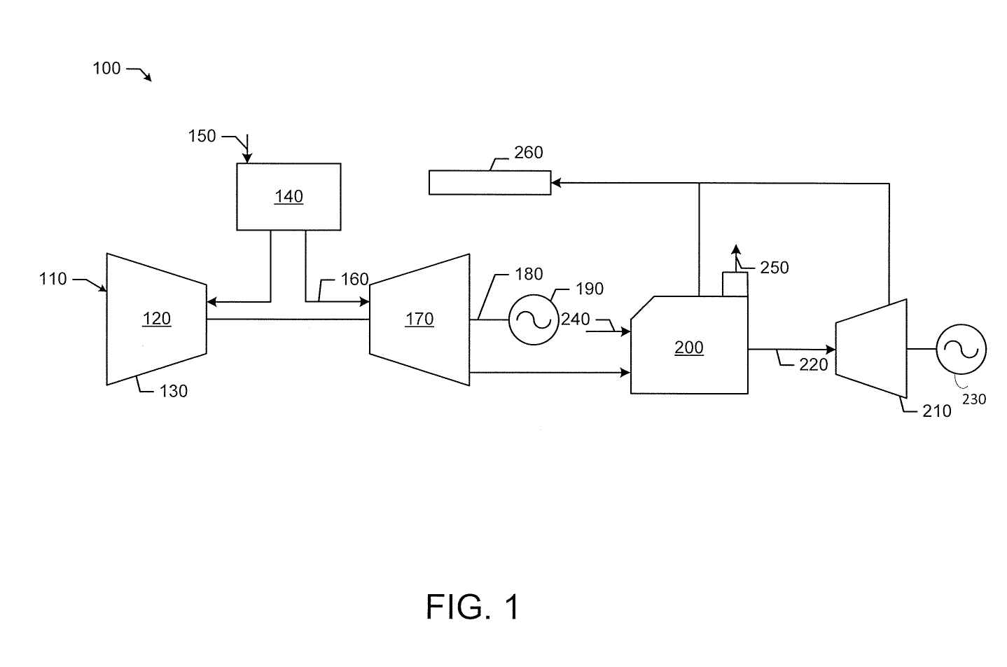

Referring now to the drawings, in which like numerals refer to like elements throughout the several views. FIG. 1 is a schematic diagram of exemplary combined cycle system 100. The combined cycle system 100 includes a gas turbine engine 110. The gas turbine engine 110 may include a compressor 120. The compressor 120 compresses an incoming flow of air 130. The compressor 120 delivers the compressed flow of air 130 to a combustor 140. The combustor 140 mixes the compressed flow of air 130 with a pressurized flow of fuel 150 and ignites the mixture to create a flow of combustion gases 160. Although only a single combustor 140 is shown, the gas turbine engine 110 may include any number of combustors 140 positioned in a circumferential array and the like. The flow of combustion gases 160 is in turn delivered to a turbine 170. The flow of combustion gases 160 drives the turbine 170 so as to produce mechanical work. The mechanical work produced in the turbine 170 drives the compressor 120 via a shaft 180 and an external load 190 such as an electric generator and the like.

The gas turbine engine 110 may use natural gas, various types of syngas, liquid fuels, and/or other types of fuels and blends thereof. The gas turbine engine 110 may have different configurations and may use other types of components. Other types of gas turbine engines also may be used herein. Multiple gas turbine engines, other types of turbines, and other types of power generation equipment also may be used herein together.

The combined cycle system 100 also may include at least one heat recovery steam generator 200 and a steam turbine 210. The heat recovery steam generator 200 may recover heat from the combustion gases 160 exiting the gas turbine engine 110 to create a flow of steam 220 for expansion in the steam turbine 210. The steam turbine 210 may drive a further load 230 such as electrical generator and the like. The heat recovery steam generator 200 may have one or more pressure sections, such as a high pressure section, an intermediate pressure section, and a low pressure section. Each pressure section may include any combination of evaporators, superheaters and/or economizers. Each of these components typically includes a bundle of tubes across which the combustion gases 160 flow, transferring heat from the combustion gases 160 to a heat exchange fluid 120 such as water flowing through the tubes. For example, the evaporator may include feedwater flowing through the tubes and the combustion gases 160 may cause the feedwater to turn to steam. The superheater may include steam flowing through the tubes and the combustion gases 160 may heat the steam to create superheated steam. The economizer may include feedwater flowing through the tubes and the hot combustion gases 160 may preheat the feedwater for use in the evaporator. The combustion gases 160 may exit the heat recovery steam generator 200 as a cooled exhaust gas 250. The steam 220 may be extracted from the steam turbine 210 and supplied to a heating and cooling application 260. Similarly, the steam 220 may be extracted from the heat recovery steam generator 200 and supplied to the heating and cooling application 260.

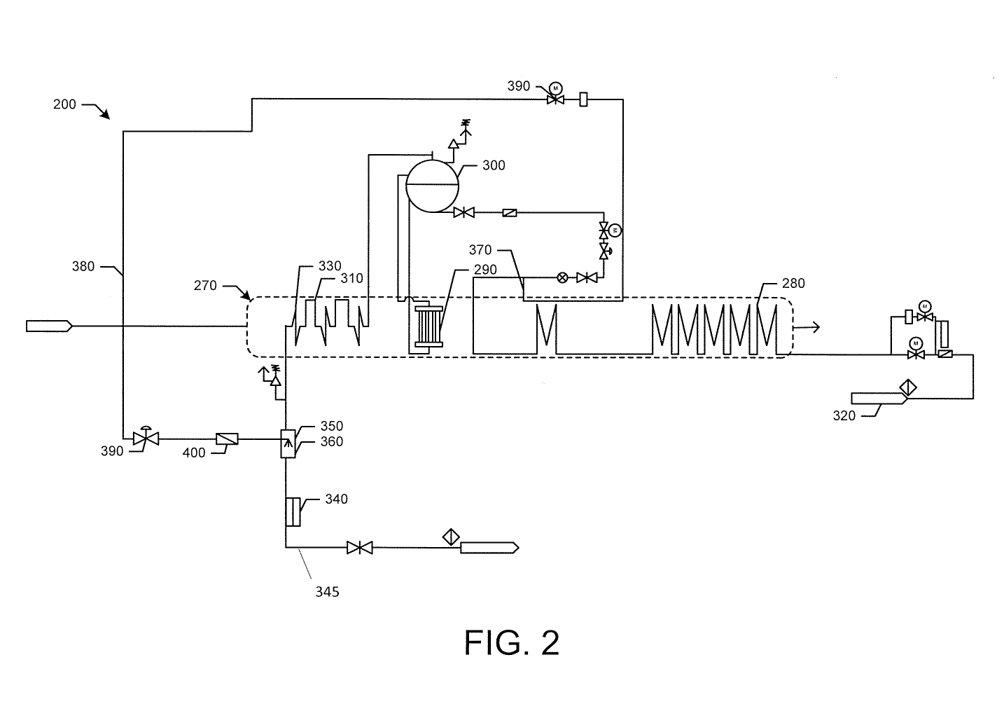

FIG. 2 shows a schematic diagram of exemplary high pressure section 270 of the heat recovery system generator 200. The high pressure section 270 may include a high pressure economizer 280, a high pressure evaporator 290 with a high pressure drum 300, and a high pressure superheater 310. The high pressure section 270 receives a flow of the combustion gases 160 from the gas turbine engine 110 and the flow of the feedwater 240 from a high pressure feedwater system 320. The flow of steam 220 exits a final stage 330 of the high pressure superheater 310 and may be routed to the steam turbine 210 via a steam pipe 340.

A desuperheater 350 may be positioned about the steam pipe 340 between the final stage 330 of the high pressure superheater 310 and the steam turbine 210. As described above, the desuperheater 350 provides a cooling flow 360 to the flow of steam 220 leaving the final stage 330 of the high pressure superheater 310 to control the temperature thereof. The steam pipe 340 generally requires an elbow 345 at a certain distance from the high pressure superheater 310. The cooling flow 360 may be an extraction from the high pressure economizer 280 and the like. An extraction line 380 may include a number of valves 390, flow controllers 400, and the like thereon.

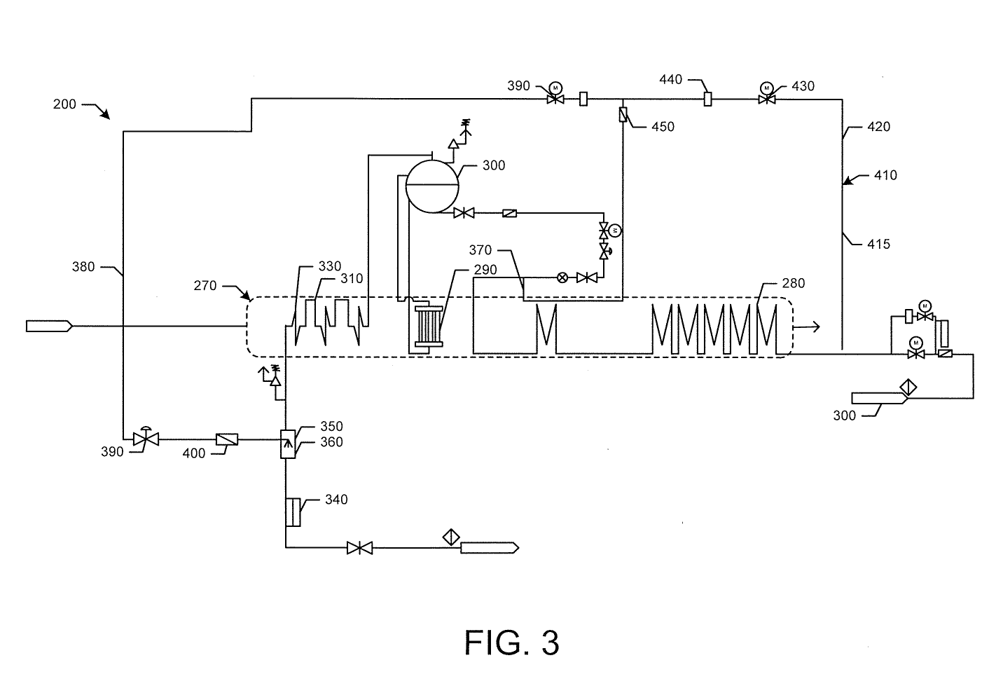

FIG. 3 shows the high pressure section 270 of the heat recovery steam generator 200 with a feedwater bypass system 410 as may be described herein. The feedwater bypass system 410 may include a bypass extraction 415 in a bypass extraction line 420. The bypass extraction line 420 may extend from upstream of the high pressure economizer 280 or elsewhere and may tie into the desuperheater extraction line 380. Alternatively, the bypass extraction line 380 may be in direct communication with the desuperheater 350. The bypass extraction line 420 may include a number of bypass valves 430, bypass flow controllers 440, and/or bypass flow controllers 450. Other components and other configurations may be used herein.

The feedwater bypass system 410 thus provides the cooling flow 360 to the desuperheater 350 from more than one extraction point. In this example, the cooling flow 360 may be extracted from upstream of the high pressure economizer 280. This flow may then be mixed with the cooling flow 360 extracted from the high pressure economizer 280. The temperature of the required cooling water for the cooling flow 360 at the desuperheater 350 thus may be adjusted by mixing these different water sources. The feedwater bypass system 410 thus ensures the required temperature set point at the outlet of the desuperheater 350 while increasing the cooling capacity of the desuperheater without increasing the water injection flow. Moreover, the feedwater bypass system 410 increases the capacity of the desuperheater 350 without increasing the risk of water impingement by reducing the water injection temperature. The flows may be mixed to meet the required specifications of water temperature set point, absolute minimum water flow, and the like. The use of the feedwater bypass system 410 may be variable depending upon operational parameters.

The feedwater bypass system 410 thus offers a cost saving benefit in the case of a retrofit because the system does not require any change to the existing desuperheater 350. More than one bypass extraction line may be used. For example, in addition to the feedwater line, the condensate line, the demi water line, and the like may be used. The existing desuperheater 350 may be used in, for example, a plant upgrade while the feedwater bypass system 410 provides increased cooling capacity without increasing the amount of injected water. Likewise, the feedwater bypass system 410 may limit the risk of pipe erosion and cracks due to a high water injection flow.

It should be apparent that the foregoing relates only to certain embodiments of the present application and the resultant patent. Numerous changes and modifications may be made herein by one of ordinary skill in the art without departing from the spirit and general scope of the invention as defined by the following claims and the equivalence thereof.

We claim:

1. A combined cycle system, comprising:
a heat recovery steam generator;
a feedwater source positioned upstream of the heat recovery steam generator;
a desuperheater positioned downstream of the heat recovery steam generator;
a first extraction from the heat recovery steam generator to the desuperheater; and
a second extraction from upstream of the heat recovery steam generator to the desuperheater.

2. The combined cycle system of claim 1, wherein the heat recovery steam generator comprises a high pressure section.

3. The combined cycle system of claim 1, wherein the heat recovery steam generator comprises an economizer.

4. The combined cycle system of claim 3, wherein the first extraction comprises a first extraction from the economizer to the desuperheater.

5. The combined cycle system of claim 3, wherein the first extraction comprises a first extraction line from the economizer to the desuperheater.

6. The combined cycle system of claim 1, wherein the heat recovery steam generator comprises a superheater.

7. The combined cycle system of claim 6, wherein the desuperheater is positioned downstream of a final stage of the superheater of the heat recovery steam generator.

8. The combined cycle system of claim 1, further comprising a steam pipe downstream of the desuperheater.

9. The combined cycle system of claim 8, wherein the steam pipe comprises a straight section and an elbow.

10. The combined cycle system of claim 1, further comprising a steam turbine downstream of the desuperheater.

11. The combined cycle system of claim 1, wherein the second extraction comprises a feedwater flow.

12. The combined cycle system of claim 1, wherein the second extraction comprises a cooling water flow.

13. The combined cycle system of claim 1, wherein the second extraction comprises a bypass extraction line in communication with the first extraction.

14. The combined cycle system of claim 1, wherein the second extraction comprises a bypass valve, a bypass flow controller, and/or a bypass flow meter.

15. A method of controlling a temperature of a flow of superheated steam from a heat recovery steam generator in a desuperheater, comprising:
flowing steam from a superheater of the heat recovery steam generator to the desuperheater;
receiving a first extraction from an economizer of the heat recovery steam generator to the desuperheater; and
variably receiving a bypass extraction of feedwater from upstream of the heat recovery steam generator to the desuperheater.

16. A combined cycle system, comprising:
a heat recovery steam generator;
the heat recovery steam generator comprising an economizer and a superheater;
a feedwater source positioned upstream of the heat recovery steam generator;
a desuperheater positioned downstream of the superheater of the heat recovery steam generator;
a first extraction from the economizer of heat recovery steam generator to the desuperheater; and
a second extraction of feedwater from upstream of the heat recovery steam generator to the desuperheater.

17. The combined cycle system of claim 16, wherein the heat recovery steam generator comprises a high pressure section.

18. The combined cycle system of claim 16, wherein the first extraction comprises a first extraction line from the economizer to the desuperheater.

19. The combined cycle system of claim 16, further comprising a steam turbine downstream of the desuperheater.

20. The combined cycle system of claim 16, wherein the second extraction comprises a bypass extraction line in communication with the first extraction.
